(19) United States
(12) Patent Application Publication
(10) Pub. No.: US 2024/0327148 A1
(43) Pub. Date: Oct. 3, 2024

(54) PRINT MEDIUM FEED

(71) Applicant: Hewlett-Packard Development Company, L.P., Spring, TX (US)

(72) Inventors: Marcel LLORACH TO, Sant Cugat del Valles (ES); Javier ONECHA CELESTINO, Sant Cugat del Valles (ES); Martin PEREZ TORRENTS, Sant Cugat del Valles (ES); Joseba ORMAECHEA SARACIBAR, Sant Cugat del Valles (ES); Ricardo SANCHIS ESTRUCH, Sant Cugat del Valles (ES)

(73) Assignee: Hewlett-Packard Development Company, L.P., Spring, TX (US)

(21) Appl. No.: 18/578,906

(22) PCT Filed: Jul. 14, 2021
(86) PCT No.: PCT/US2021/041652

§ 371 Date: Jan. 12, 2024

(51) Int. Cl. B65H 3/06; B65H 5/06

(52) U.S. Cl. CPC B65H 3/0638; B65H 3/0684; B65H 5/068; B65H 2404/1521

(57) ABSTRACT

Disclosed are a printing device, a system and a method for printing medium feed. A device may comprise a support member and multiple rollers. The support member may support a print medium. The multiple rollers may each advance the print medium from the support member in an advance direction. The multiple rollers are arranged in a distributed manner along a width direction. The multiple rollers are operable in a disengage state detached from the print medium and the support member and in an engage state of pressing against the support member such to rest on the print medium or, if the print medium does not extend therebetween, to rest on the support member. The multiple rollers in the engage state are individually movable toward the support member.

### BACKGROUND

A print medium feed relates to transport of a print medium for the purpose of printing. The print medium feed may be used in a printing system, in a printing device or in a method of operating a printing system or a printing device. The print medium may be provided as a sheet, as a stack of sheets or from a continuous supply.

### BRIEF DESCRIPTION OF DRAWINGS

The present disclosure is described in the following with reference to examples presented in the accompanying drawings. The examples shown in the drawings only serve the purpose of a detailed understanding of particular aspects of the present disclosure without limiting the scope of the scope of the present disclosure thereto. Furthermore, the examples in the drawings are not up-to-scale but depicted in an arbitrary scale for the sake of comprehensibility. In the drawings and the corresponding specification, similar, like or identical features are indicated with the same reference sign.

FIG. 1 is a schematic plan view of a printing device according to examples.

FIG. 2A to 2E are schematic front views of a printing device according to examples.

FIGS. 3A and 3C are a schematic side views of a printing device according to examples.

FIG. 4 is a schematic side view of a printing device according to examples.

FIGS. 5A and 5B are schematic side views of a printing device according to examples.

FIGS. 6A and 6B are schematic side views of a printing device according to examples.

FIGS. 7A and 7B are schematic side views of a printing device according to examples.

FIGS. 8A and 8B are a schematic side view and a schematic front view, respectively, of a printing device according to examples.

FIG. 9 is a schematic plan view of a printing device according to examples.

FIG. 10 is a schematic front view of a printing device and different sizes of a print medium according to examples.

FIG. 11 is a flow diagram of a method according to examples.

### DETAILED DESCRIPTION

The present disclosure refers to a system and device for the print medium feed. The examples for the print medium feed as disclosed herein may be used in combination with a printing device suitable for printing on variable-width print media and in particular with a large format printing device designed to print on print media having a DIN A3 and larger format.

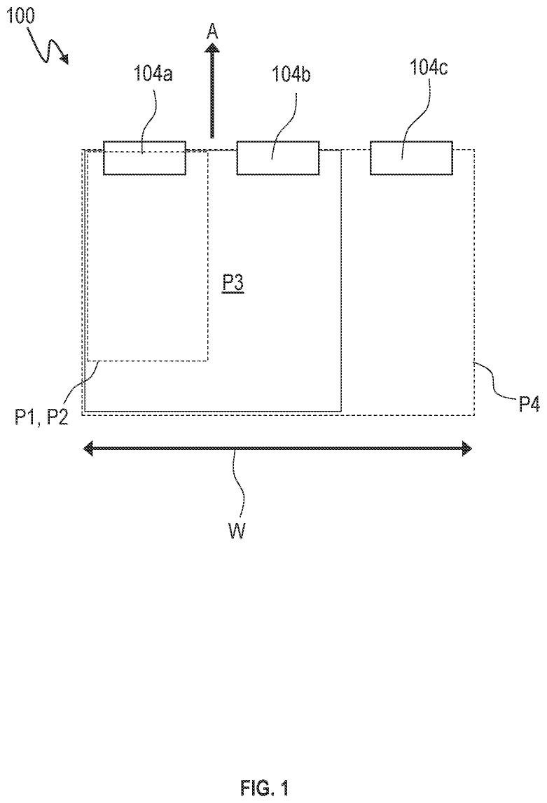

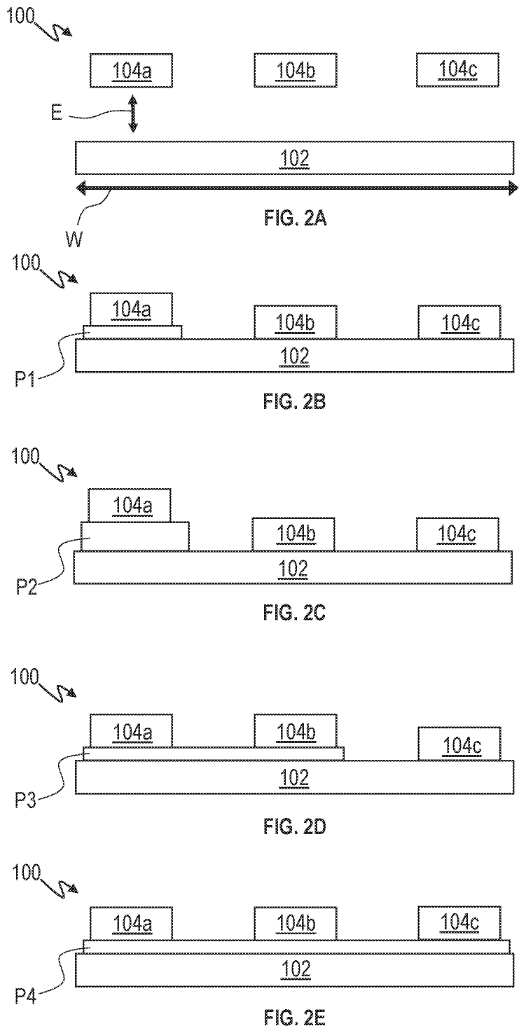

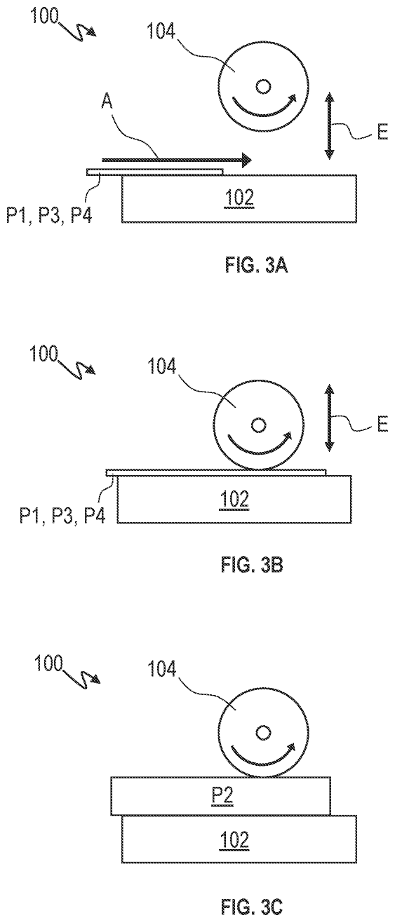

Referring to FIGS. 1 to 3C, a system 100 for print medium feed according to an example is provided, wherein FIG. 1 shows a schematic plan view, FIG. 2A to 2E each show a schematic front view, FIG. 3A to 3C each show a schematic side view. Generally, the system 100 as disclosed herein may be part of a device that uses cut sheet media. In specific examples, the system 100 as disclosed herein may be part of a printing device, a laminating device or a (paper) bag folding device. Hereinafter, the system 100 may also be referred to as a printing device 100 in a simplifying manner.

According to an aspect of the present disclosure, the printing device 100 may comprise a support member 102 and multiple rollers 104a to 104c. Hereinafter, the rollers 104a to 104c may be referred to, collectively, as rollers 104 for simplicity. Each of the (multiple) rollers 104 may be any of a feed roller, a prepick roller or an advance roller as described in detail below. While three rollers 104a, 104b and 104c are depicted in FIGS. 1 and 2, the number of the rollers 104 is illustrative and exemplary only. The present disclosure is not limited to three rollers. The number of the rollers of the printing device 100 may be any integer of two or greater. The number of the rollers is not limited and, for example, may reach two hundred.

According to a further aspect of the present disclosure as described in detail below, the system 100 may more generally comprise at least one roller 104. The at least one roller 104 may be a feed roller, a prepick roller or an advance roller as described in detail below. The at least one roller 104 may refer to any of the aforementioned rollers 104a to 104c. In the drawings where a single roller 104 is shown in a side view, it is understood that the features illustrated and described in the corresponding passages in the specification may also apply to any of the multiple rollers 104. Similarly, any features described herein with reference to a general roller 104 may be applicable to any of the multiple rollers 104, unless otherwise indicated.

An outer surface of any of the rollers 104 may be provided with a material which has a sufficient friction coefficient against a material of the print medium P. The friction coefficient may be considered sufficient, if a traction applied by a rolling movement of the rollers 104 suffice to advance the print medium P in the advance direction. For example, the rollers 104 may be comprise a rubber material on the outer surfaces such to provide a high friction coefficient against paper, cardboard or a specific synthetic material. Further, the rollers 104 may be subjected to a surface treatment to increase the friction coefficient against paper.

The support member 102 may be arranged to support a print medium P1, P2, P3 and P4, which may be collectively or generally referred to as a print medium P. The print media P1, P2, P3 and P4 as depicted in FIGS. 1 and 2 may differ from one another in at least one of a width and a thickness. The width may refer to a size in a width direction W. The thickness may refer to a size in a direction perpendicular to the width direction W and also to an advance direction A (described below). In the examples depicted in FIGS. 1 and 2, the print medium P1 and the print medium P2 may have a same width but different thicknesses; the print medium P1, the print medium P3 and the print medium P4 may have a same thickness, but different widths.

The print medium P may be made of any material suitable to be printed. For example, the print medium P may comprise paper, cardboard, a synthetic material, a woven material, or any combination thereof. The print medium P may be provided as a single sheet, or as multiple sheets, for example, as a stack of sheets. Additionally or alternatively, the print medium P may be provided in a continuous manner, for example, wounded on a roll core or as a folded stack. A size of the print medium P may be variable, and may be any standard paper size, such as DIN A1 to DIN A10, or any arbitrary size with a width of 510 mm or more, 1020 mm or more, 1500 mm or more, 2000 mm or more, and for example up to 104 mm. Furthermore, the print medium may have a default thickness for a paper sheet, cardboard or the respective material, or any arbitrary thickness of 10 mm or more, 20 mm or more, for example up to 200 mm.

The support member 102 may comprise at least one of an arrest surface, a guide surface or one or more baffles each arranged to support the print medium P. Additionally or alternatively, the support member 102 may comprise a tray to store the print medium P.

The rollers 104 may be arranged in a distributed manner along the width direction W. In particular, the rollers 104 may be arranged such that one of the rollers 104 is arranged such to be associated with a first print medium width, and another one of the rollers 104 is arranged such to be associated with a second print medium width that is different from the first print medium width. In the specific examples shown in FIGS. 1 and 2A to 2E, the first print medium width may correspond to a width of the print media P1 and P2 and the second print medium width may correspond to a width of any of the print media P3 and P4. Accordingly, the one roller of the rollers 104 may refer to the roller 104a, and the another roller may be the roller 104b (corresponding to the print medium P3) or the roller 104c (corresponding to the print medium P4).

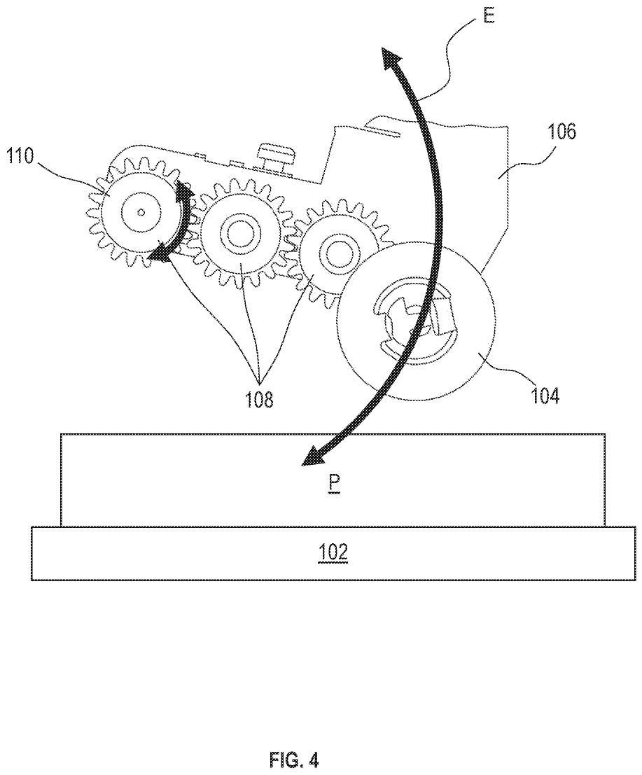

The rollers 104 may be each arranged to advance the print medium P from the support member 102 in an advance direction A. For this purpose, the rollers 104 may roll in a direction as indicated by a respective arrow in FIG. 3A to 4B. The advance direction A may be defined as a process direction of the print medium P for the purpose of printing. In particular, the advance direction may refer to a direction from the support member 102 to a print zone (not shown in the drawings) in which a print fluid may be deposited onto the print medium P. In such examples, the rollers 104 may be particularly arranged to feed a single print medium sheet from the support member 102 to the print zone in the advance direction A. The advance direction may be perpendicular to the width direction W.

In general, any of the rollers 104 disclosed herein may be any roller used in a printing device for advancing the print medium P in a (print) process direction. The rollers 104 may apply a traction and normal force onto the print medium P to move the print medium P in the advance direction. In examples where the print medium P is provided as a stack of sheets, the rollers 104 may move an uppermost sheet or uppermost sheets of the stack of sheets in the above manner.

Two particular examples of the roller 104 are a prepick roller and a feed roller. The feed roller may be referred to as a sheetfeeder. A feed roller may be arranged to advance the print medium P in the advance direction A as described above. Furthermore, the feed roller may be arranged to pick an uppermost sheet from a stack of sheets. The feed roller may be also referred to as an advance roller to advance the print medium to or towards a print zone. The feed roller may also be referred to as sheetfeeder.

A prepick roller may be used in examples where the print medium is supplied as a stack of sheets. The prepick roller may be used for a preliminary separation of an uppermost sheet or uppermost sheets of the stack of sheets, thereby providing prepicked sheets. Then a singulation system may be used to separate a single sheet from the prepicked sheets.

The rollers 104 may be operable in a disengage state. In the disengage state, the rollers 104 may be detached from the print medium P and the support member 102. The rollers 104 in the disengage state may be lifted such to be detached from a top surface of the print medium P and from a top surface of the support member 102. The examples shown in FIGS. 2A and 3A may illustrate the rollers 104 in the disengage state. For example, the rollers 104 may have been lifted in an engage direction (or disengage direction) E away from the support member 102 to be in the disengage state, as for example shown in FIGS. 2A and 3A.

In some examples, the printing device 100 may further comprise a lock device (not shown in FIGS. 1 to 3C), such as a movable cam. In particular, each of the rollers 104 may be provided with a respective lock device. The lock device may be arranged such to move all of the rollers 104 into the disengage state or to release all of the rollers 104 into the engage state, thereby allow the rollers 104 to move freely in the engage direction E. The lock device may be operable to bring the rollers into the disengage state and keep (lock, maintain) the rollers 104 in the disengage state.

The rollers 104 may be operable in an engage state. In the engage state, the rollers 104 may be pulled towards (pressed against, forced towards) the support member 102. As such, if the print medium P is present between any of the rollers and the support member 102, this roller may rest on the print medium P, may press against the print medium P, or may press the print medium P against the support member 102. Alternatively or additionally, if the print medium P does not extend therebetween, the rollers 104 in the engage state may rest on the support member 102. In the engage state, the rollers 104 may be individually movable toward the support member 102. The printing device 100 may comprise a load unit (not shown in the drawings), for example a tension spring, a torsion spring or a rubber band, that is arranged such to exert a tensile force or a pressing force, or both, on the rollers 104 towards the support member 102. As such, the rollers 104 may be pulled towards (pressed against) the support member 102. The load unit may be referred to as a preload system. A corresponding spring coefficient may be adjusted such that a resulting normal force does not change too much with different media thickness.

Moreover, the printing device 100 may be arranged such that the rollers 104 are pulled towards the support member 102 by their own weight, i.e., due to the gravitational pull. In such an example, the printing device 100 may comprise a lock unit to keep the rollers 104 in the disengage state against the gravitational pull. In the engage state, the lock unit may further be operable to release the rollers 104 to be pulled by the gravity and thereby pressed against the support member 102.

Accordingly, in the engage state, the rollers 104 are capable of being individually displaced in the engage direction. In particular, the rollers 104 in the engage state may fall freely either onto the top surface of the print medium P, if the print medium P extends below the respective roller 104, or onto the support member 102. As such, each of the rollers 104 may be arranged at a respective target distance from the support member.

In some examples, where the rollers 104 are coupled to a common shaft that is fixedly positioned (i.e., immovable except for the rotation around its own axis), the rollers 104 may be arranged to move along a predetermined path (e.g., an arc, a linear path, a curved path) relative to the common shaft in the engage direction. More generally, the printing device 100 may comprise a shaft 110 to transmit a torque, wherein the multiple rollers 104 are each mechanically coupled to the shaft 110 to be driven by the torque received from the shaft 110.

For example, the rollers 104 may be each mounted on a respective module, and the modules may be pivotable around the common shaft to move the rollers 104 in the engage direction, thereby switching between the disengage state and the engage state and, in the engage state, allowing the rollers 104 to (freely) move in the engage direction. In the present disclosure, a module may also be referred to as an arm.

In examples where a common shaft is used to transmit torque to the rollers 104, the printing device 100 may further comprise a transmission gear to transmit the torque from the (common) shaft to a respective roller of the rollers 104. The printing device 100 may comprise multiple transmission gears, one for each of the rollers 104. The transmission gear (or each of the transmission gears) may comprise a single gear or a series of gears to transmit torque to the respective roller 104. The transmission gear may avoid that an actuator is mounted on the same module as the respective roller 104.

In particular, in the engage state, the rollers 104 may be freely movable in the engage direction. In the present disclosure, being freely movable may indicate that the roller 104 may move towards the support member 102 in the engage direction without mechanical hindrances until resting on the top surface of the print medium or the support member 102. As such, in the engage state, the rollers 104 may be released (as opposed to being locked in the disengage state) without a predefined lock position. Such arrangement may allow operability with any print media thickness.

FIG. 4 shows a schematic side view of an example of the roller 104 mounted on a module 106. A transmission gear 108 is mounted on a module 106. The roller 104 is mechanically coupled to a shaft 110 via the transmission gear 108. In the example shown in FIG. 4, the transmission gear 108 comprises three gears. The module 106 may be pivotable around the shaft 110, thereby moving the rollers 104 in the engage direction E. The module 106 may be pivoted such that the roller 104 switch between the disengage state and the engage state. Furthermore, in the engage state, the module 106 may be freely pivotable to allow the roller 104 to freely move in the engage direction E. The roller 104 as shown in FIG. 4 may be a prepick roller as described above. The example described with reference to FIG. 4 may be applicable to any of the rollers 104 described above.

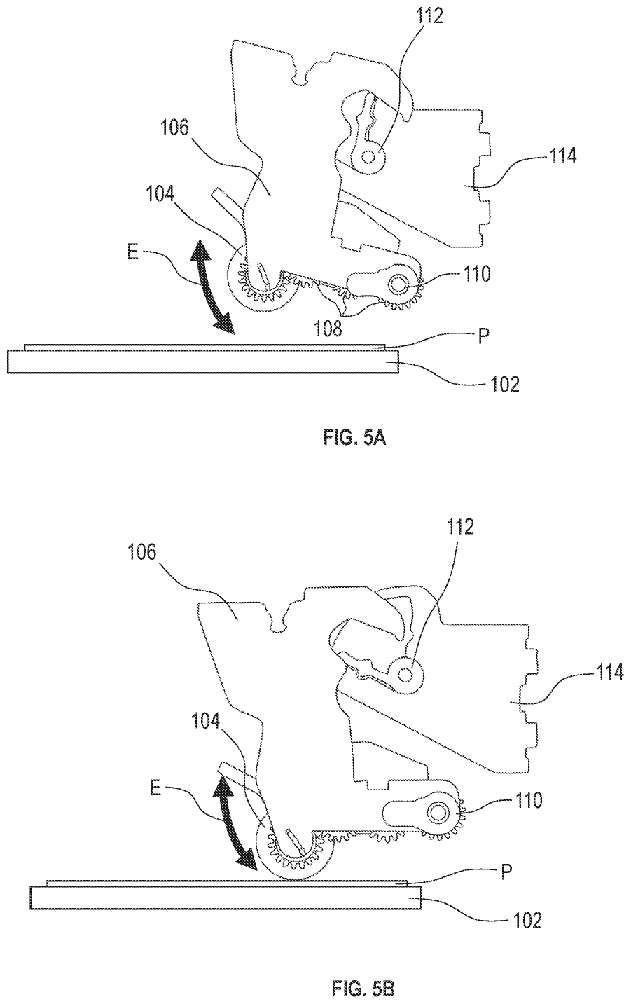

FIGS. 5A and 5B show schematic side views of another example, in which the roller 104 mounted on a module 106. The module 106, the transmission gear 108 and the shaft 110 may be arranged as described above. In some examples, the printing device 100 may comprise a lock device to detach the rollers 104 from the support member 102 or the print medium P and to keep the rollers 104 in the disengage state.

In the disengage state as shown in FIG. 5A, the module 106 may be locked using a lock device 112 in a position from which the roller 104 cannot reach the top surface of the print medium P or the support member 102. For example, the lock device 112 may comprise a pivotable cam. In particular, the lock device 112 may be arranged to lock the module 106 in an immovable position relative to a housing 114 of the printing device 100. The module 106 may have a shape such to engage with the lock device 112 in order to be moved between the disengage state and the engage state by the lock device 112.

As shown in FIG. 5A, the cam 112 may be in a pivot position to lock the module 106 in the disengage state, for example in an elevated position. In the engage state for example shown in FIG. 5B, the cam 112 is in a different pivot position, in which the module 106 and the lock device 112 do not engage with each other. Accordingly, in the engage state as shown in FIG. 5B, the module 106, and thus the roller 104, may be freely movable in the engage direction E. The roller 104 as shown in FIGS. 5A and 5B may be a feed roller (a sheetfeeder) as described above. The example described with reference to FIGS. 5A and 5B may be applicable to any of the rollers 104 described above.

Furthermore, each of the rollers 104 (or the modules as described above), in the engage state, may be individually movable in the engage direction. In the present disclosure, the rollers 104 being individually movable, or movable in an individual manner, may indicate that positions of the rollers 104 in the engage direction may differ from one another. In particular, in the engage state, the rollers 104 may be movable in the engage direction in an independent manner from one another. In the engage state, the movement and the position of any one the rollers 104 in the engage direction may not affect the movement and the position of any other one of the rollers 104 in the engage direction.

The examples shown in FIGS. 2B to 2E, 3B and 3C each depict the rollers 104a to 104c in the engage state. According to the different widths of the print media P1 to P4, the rollers 104a to 104c either rest on the print medium P or on the support member 102. Furthermore, the rollers 104a to 104c may be subject to a tensile force towards the support member 102 as described above, thereby being pressed against the support member 102. As a result, if the print medium P extends (i.e., is present) between the support member 102 and the respective roller 104, the respective roller 104 may rest on the print medium P, may press against the print medium P, or press the print medium P against the support member 102. In the present disclosure, the expressions “press against”, “force against” and “pull towards” may be used in interchangeable manner unless otherwise indicated.

In the specific example shown in FIG. 2B, in the print medium P1 has a width such to extend between the roller 104a and the support member 102 when aligned to a stop on the left-hand side (in the orientation of the drawings). The width of the print medium P1 is such that the print medium P1 does not reach the other rollers 104b and 104c. Accordingly, the roller 104a may rest on the print medium P1. The other rollers 104b and 104c rest on the support member 102.

In the specific example shown in FIGS. 2B and 2C, the print media P1 and P2 each have a width such to extend between the roller 104a and the support member 102 when aligned to a stop on the left-hand side (in the orientation of the drawings). The width of the print media P1 and P2 is such that the print medium P1 does not reach the other rollers 104b and 104c. Accordingly, the roller 104a rests on the print media P1 and P2 in the engage state, as also shown in FIGS. 3B and 3C. Further, the roller 104a may press the print media P1 and P2 towards the support member 102 in the above described manner. The other rollers 104b and 104c rest on the support member 102.

In the specific example shown in FIG. 2D, the print medium P3 has a width such to extend below the rollers 104a and 104b when aligned to a stop on the left-hand side (in the orientation of the drawings). Accordingly, the rollers 104a and 104b rest on the print medium P3 in the engage state. Further, the rollers 104a and 104b may press the print medium P3 towards the support member 102 in the above described manner. At the same time, the roller 104c may rest on the support member 102.

In the specific example shown in FIG. 2E, the print medium P4 has a width such to extend below all the rollers 104a, 104b and 104c when aligned to a stop on the left-hand side (in the orientation of the drawings). Accordingly, the rollers 104a to 104c may rest on the print medium P4 in the engage state. Further, the rollers 104a to 104c may press the print medium P4 towards the support member 102 in the above described manner.

Furthermore, the rollers 104 in the engage state may be individually movable in the engage direction E. As shown in FIG. 2B in connection with FIG. 3B, and FIG. 2C in connection with FIG. 3C, the roller 104a in this example, and any of the rollers 104 in general, may be movable such to rest on the print media P1 and P2 regardless of the different thicknesses.

A magnitude of torque driving the rollers 104 may be adjusted according to a roll resistance occurring on the rollers 104, the traction and the normal force applied by the rollers 104, material properties on outer surfaces of the rollers 104 and the print medium P, and inertia of torque of the rollers 104. A proper adjustment of the torque driving the rollers 104 may maintain a failure-free operation of the printing device and the system as disclosed herein.

Accordingly, one aspect of the present disclosure provides using multiple rollers 104 for printing on print media of variable widths, for example up to 104 mm. In a comparative example where a single feed roller is used, the print medium may tend to bend or warp when moved by this single roller, if the print medium does not have a sufficient rigidity. The challenge arising from such a low rigidity of the print medium may be addressed by the use of the multiple feed rollers arranged in a distributed manner along a width direction.

As such, the present disclosure may provide a printing device or a system, in particular a print medium feed system, or a method of operating thereof which allows for print medium feed in a cost, material and energy saving manner with a reduced space requirement. Specifically, the present disclosure employs elementary mechanisms of rollers being movably arranged in the engage direction, thereby avoiding complexity and cost for a print medium feed system for wide print media. In particular, in comparison to systems generating a pressure gradient across a conveying belt, the present disclosure may allow printing on print media of variable widths in an efficient manner in terms of costs, energy consumption.

The present disclosure may allow for an accurate feed of print media of any standard sizes. In addition, the present disclosure may allow for an accurate feed of print media of variable sizes without being limited to any default, preset or standard print medium sizes. In particular, the present disclosure may be operable with print media having a large width of, for example, up to 104 millimeters. Moreover, as the rollers are movable in the engage direction, the present disclosure may be operable with print media of variable thicknesses, including standard print medium thicknesses. For example, the present disclosure may be operable with print media having a thickness of up to 200 millimeters. Accordingly, the versatility, practicability and applicability of a printing device, a system and an operating method thereof may be increased. As such, the present disclosure may allow for using print media of widely variable sizes in all three dimensions without any extra hardware changes by a user. In particular, no extra hardware, such as vacuum device or sensor, is required.

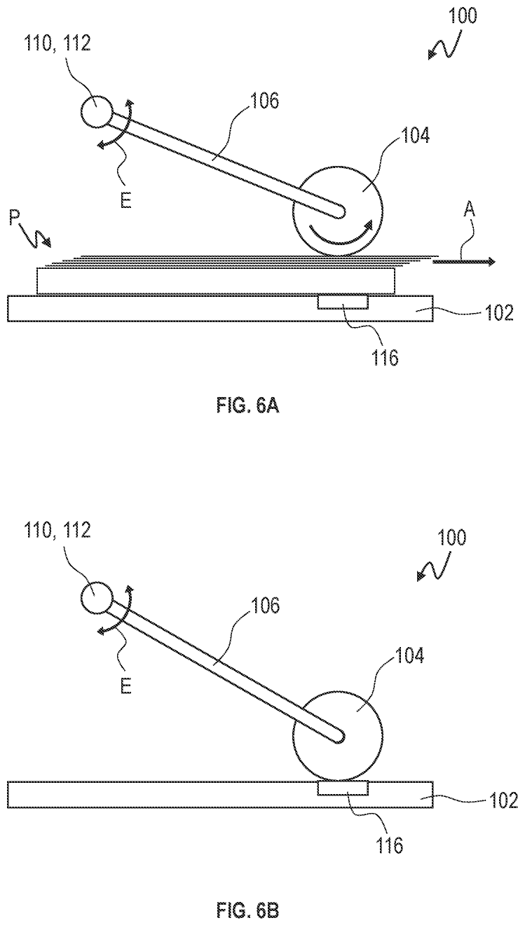

FIGS. 6A and 6B are schematic side views of an examples of the printing device 100. The printing device 100 of FIG. 6A or 6B may inherit any of the features described above with reference to FIGS. 1 to 5B unless indicated otherwise. Specification of same or like features are not repeated for the sake of brevity. Described below are additional features comprised in the examples of FIGS. 6A and 6B.

In some examples, for example those shown in FIGS. 6A and 6B, the printing device 100 may comprise an arrest member 116 arranged under the roller 104. In particular, the support member 102 may comprise the arrest member 116. The arrest member 116 may hold the stack of sheets until a lowermost sheet. In other words, the arrest member 116 may arranged such to avoid that, if the print medium P is provided as a stack of sheets, the full stack of sheets is moved by the rolling movement of the roller 104.

In examples where the printing device 100 comprises multiple rollers 104, the support member 102 may comprise an arrest member 116 arranged below any one of the rollers 104 such that the one roller 104 abuts against the arrest member 116 if no print medium P is present between the one roller 104 and the arrest member 116, and that the arrest member 116 supports the print medium P if the print medium P extends between the one roller 104 and the arrest member 116.

In FIG. 6A, the print medium P is provided as a stack of sheets. The roller 104 in FIG. 6A may be used as a prepick roller. The roller 104 may be mounted on a module 106, which in FIG. 6A is depicted as a bar in a simplified manner. The module 106 may be movable in the engage direction E as described above.

In FIGS. 6A and 6B, the roller 104 is in the engage state. The roller 104 and the module 106 may be movable in the engage direction E by means of the shaft 110 or the lock device 112 in the above described manner. The roller 104 rests on the top surface of the print medium P in FIG. 6A and rests on the support member 102, or more specifically, on the arrest member 116 of the support member 102, in FIG. 6B. By the rolling movement as indicated by an arrow in FIG. 6A, the roller 104 moves uppermost sheets of the stack of sheets of the print medium P in the advance direction A. At the same time, the arrest member 116 keeps a lower part, at least a lowermost sheet, of the stack of sheets of the print medium P in position. In other words, the arrest member 116 prevents the whole stack of sheets being moved by the roller 104 in the advance direction. For this purpose, the arrest member 116 may be made of a material providing a sufficient friction coefficient against the surface of the print medium which may be any of the materials indicated above.

The arrest member 116 may be provided such that a friction coefficient between the surface of the print medium P and the roller 104 exceeds a friction force between the print medium surface and the arrest member in order to allow the lowermost sheet to be moved by the roller. Furthermore, the arrest member 116 may be disposed immovably in the support member 102. In particular, materials of the feed roller and the arrest member may be selected, in connection with the material of the print medium, such that the friction force of the print medium against the arrest member is smaller than the friction force of the print medium against the feed roller. At the same time, the normal force exerted by the feed roller onto the print medium may also be considered. When the print medium P does not extend below the roller 104 as shown in FIG. 6B, the roller 104 may rest on the support member 102, in particular on the arrest member 116.

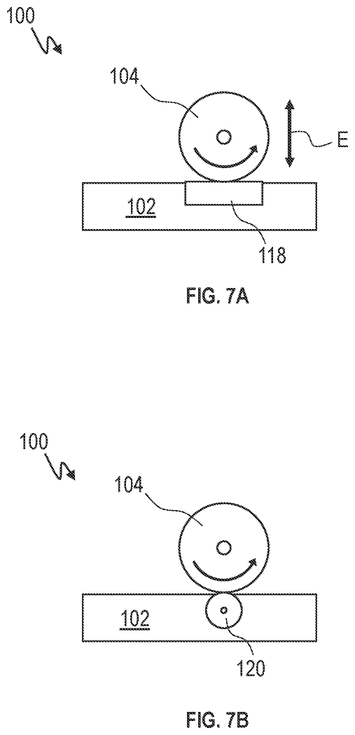

In some examples, the arrest member 116 may comprise an arrest pad 118 arranged under the roller 104 as shown in FIG. 7A. The arrest pad 118 may comprise an (upper) contact surface that provides a sufficient friction coefficient against the material of the print medium P (e.g., paper). The arrest pad 118 may be made of a rubber material and may be referred to as a rubber pad. The arrest pad 118 may arranged such to avoid that, if the print medium P is provided as a stack of sheets, the full stack of sheets is moved by the rolling movement (indicated by a curved arrow) of the roller 104.

In such examples, the printing device 100 may further comprise a torque limiter (not shown in the drawings) mechanically coupled to one of the rollers 104 to limit a torque output by the one roller 104. Generally, a torque limiter may refer to a machine element for coupling two rotatable parts, such as rollers, gears and shafts, such to allow a torque to be transmitted or to be partially transmitted, or to stop a torque transmission entirely. The torque limiter may also be referred to as a slipping clutch. A specific example of the torque limiter may be given by the OTL-P series, for example OTLP6-100, OTLP6-200, OTLP6-300, OTLP6-500 or OTLP6-500A, by Origin Electric Co. Ltd., Japan.

In specific examples, the torque limiter may be coupled between the roller 104 and the shaft 110 such to allow the roller 104 to rotate (i.e., receive the torque from the shaft 110) when resting on top of the print medium P, and to stop the roller 104 (i.e., stop torque transmission) when abutting against the arrest member 116. For example, the torque limiter may transmit the torque from the shaft 110 to the roller 104 as long as a roll resistance at the roller 104 is below a threshold torque of the torque limiter, and decouple the roller 104 from the shaft 110 if the roll resistance at the roller 104 exceeds the threshold torque of the torque limiter. The threshold torque of the torque limiter may be adjusted accordingly. In particular, the threshold torque of the torque limiter may be adjusted such to overcome the friction between the arrest pad 118 and the print medium P.

Alternatively or additionally, as shown in FIG. 7B, the support member 102 may comprise an arrest roller 120 arranged below the roller 104. In examples where the printing device 100 comprises multiple rollers 104, the support member 102 may comprise an arrest roller 120 arranged below any one of the rollers 104 such that the one roller 104 abuts against the arrest roller 120 if no print medium P is present between the one roller 104 and the arrest roller 120, and that the arrest roller 120 supports the print medium P if the print medium P extends between the one roller 104 and the arrest roller 120. In particular, the support member 120 may comprise multiple arrest rollers each provided for a respective one of the multiple rollers 104.

In some examples, the multiple rollers 104 may be arranged such to physically contact an upper surface of the print medium P. The arrest roller 120 may provide an inertia of torque exerting a surface force on a lower surface of the print medium P. The lower surface of the print medium P may also refer to the lower surface of a lowermost sheet of a stack of sheets. The arrest roller 120 may provide friction to apply the surface force to the lower surface of the print medium P. The arrest roller 120 may arranged such to avoid that, if the print medium P is provided as a stack of sheets, the full stack of sheets is moved by the rolling movement (indicated by a curved arrow) of the roller 104.

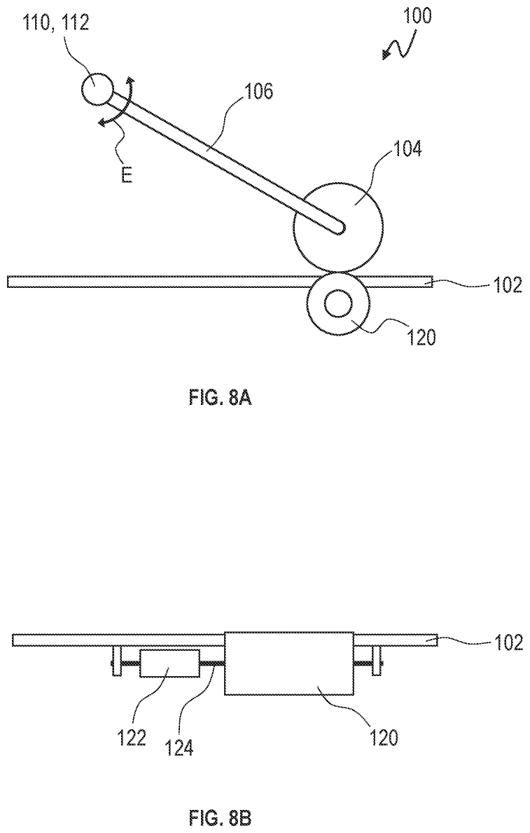

FIGS. 7B, 8A and 8B show operation situations where no print medium P is present between the roller 104 and the arrest roller 120. The roller 104 rests on the arrest roller 120. The arrest roller 120 may be arranged to roll in response to the torque from the roller 104, thereby preventing that the roll movement of the roller 104 is blocked when no print medium P is present below the roller 104.

The arrest roller 120 may be further coupled to a torque limiter 122 as shown in FIG. 8B. The torque limiter 122 may be as described above. The torque limiter 122 may be coupled to the arrest roller 120 via a shaft 124. The torque limiter 122 and the shaft 124 may be arranged below the support member 102.

Accordingly, in some examples, the printing device 100 may comprise a torque limiter 122 mechanically coupled to the arrest roller 120 to allow the arrest roller 120 to be rotated by the corresponding roller 104 if no print medium P is present between this roller 104 and the arrest roller 120, and otherwise to block rotation of the arrest roller 120. Alternatively, a mechanical element that increases the inertia of torque may be coupled to the arrest roller 120 to exhibit rotation when the print medium P is on the arrest roller 120 and to allow rotation when the corresponding roller 104 is in contact with the arrest roller 120.

The torque limiter 122 may block the rolling movement of the arrest roller 120 as long as a torque received on the shaft 124 is below a threshold torque of the torque limiter 122. This may correspond to an operational situation where the print medium P is present between the roller 104 and the arrest roller 120 (not shown in FIGS. 7B, 8A and 8B).

When the roller 104 rests on (abuts against) the arrest roller 120, part of the torque driving the roller 104 is received on the shaft 124. The torque limiter 122 may be arranged such that the torque received from the roller 104 on the shaft 124 exceeds the threshold torque of the torque limiter 122. As a result, the torque limiter may allow the arrest roller 120 to roll in response to the torque received from the roller 104. Accordingly, the rolling movement of the roller 104 may not be blocked, even if no print medium P is present between the roller 104 and the arrest roller 120.

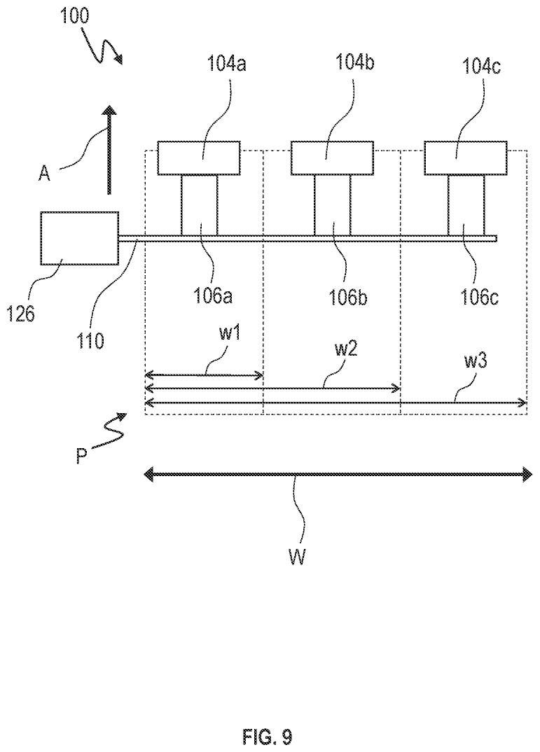

The benefits of the above arrangement may be further increased with examples, in which the rollers 104 are driven (collectively) by a single actuator 126, see FIG. 9. The present disclosure also contemplates that at least two actuators may be provided to drive the rollers 104. However, driving the rollers 104a to 104c by the single actuator 126, as shown in FIG. 9, may reduce cost, energy consumption, material and space requirement in comparison to using multiple actuators.

Yet, if using a single actuator, a single shaft 110 may be used to transmits torque from the actuator 126 to each of the rollers 104a to 104c. This may lead to an operational situation in which all of the rollers 104a to 104c may be blocked if any one of the rollers 104a to 104c is blocked.

In FIG. 9, the rollers 104a to 104c may be coupled to the common shaft 110 that may transmit torque from an actuator 126 to each of the rollers 104a to 104c. The rollers 104a to 104c may be mounted on a respective module arm 106a to 106c. While three rollers 104a to 104c are shown in FIG. 9, the number of the rollers 104 may differ in other examples as described above.

The print medium P may have a variable width w1, w2 or w3, thereby extending below different numbers of the rollers 104a to a04c. If the print medium P does not extend over an entire distance between the outermost rollers 104a and 104c, those of the rollers 104a to 104c not covered by the print medium P may rest on the support member 102, the arrest member 116, the arrest pad 118 or the arrest roller 120 as described above. Otherwise, the rollers 104a to 104c may rest on the top surface of the print medium P to advance the print medium P in the advance direction A. In particular, since the rollers 104 are individually movable in the engage direction as described above, some of the rollers 104a to 104c may rest on the print medium P and others may rest on the support member 102, the arrest member 116, the arrest pad 118 or the arrest roller 120 in the above described manner.

Accordingly, only those rollers 104 corresponding to the actual paper width w1, w2 or w3 may engage with the print medium P. If the width of the print medium is small and thus not all the rollers 104a to 104c are required to advance the print medium P in the advance direction, the rollers 104a to 104c outside the print medium area rest on the support member 102, the arrest member 116, the arrest pad 118 or the arrest roller 120 without affecting the advancing of the print medium P or the rolling movement of the other rollers 104a to 104c. Accordingly, the present disclosure allows for printing with print media of variable width. The present disclosure may further achieve that the traction over the print medium P is proportional to the width of the print medium P.

In the example of FIG. 9, multiple arrest rollers 120 (not shown in FIG. 9, instead refer to FIGS. 7B, 8A or 8B) may be provided each below a respective one of the rollers 104a to 104c. Accordingly, when no print medium P is present below any of the rollers 104a to 104c, this roller 104a to 104c may rest on the respective arrest roller 120 that allows the rollers 104a to 104c to continue rolling in the above described manner.

In particular, a torque limiter 122 may be provided as described above (not shown in FIG. 9, refer to FIGS. 8A and 8B). In particular, the threshold torque of the torque limiter 122 may be adjusted such to retain the stack of sheets of the print medium P and, at the same time, to allow the rollers 104 to rotate when resting on the arrest roller 120. Accordingly, when any of the rollers 104a to 104c rests on the arrest roller 120, the torque limiter 122 will activate and keep all of the rollers 104a to 104c rolling without blocking the actuator 126.

If the print medium P is present between the rollers 104a to 104c and the arrest roller 120, the arrest roller 120 may keep the print medium P in place, i.e., prevent an entire stack of sheets of the print medium P being pulled by the rollers 104a to 104c. At the same time, the (optional) torque limiter 122 may restrain the rotation of the arrest roller 120 in the above described manner.

An aspect of the present disclosure provides a system, in particular a system to feed a print medium to a print zone of a printing device 100. The system may comprise the feed roller 104, an arrest roller 120 and the torque limiter 122, each of which may be as described above. The feed roller 104 may advance the print medium P in the advance direction A. The arrest roller 120 may be arranged below the feed roller 104 such that the arrest roller 120 supports the print medium P if the print medium P is present between the feed roller 104 and the arrest roller 120, and that the feed roller 104 abuts against the arrest roller 120 if no print medium P is present between the feed roller 104 and the arrest roller 120. The torque limiter 122 may be mechanically coupled to the arrest roller 120. In some examples, the feed roller 104 may be movable in an engage direction E such to contact an upper surface of the print medium P or to be detached therefrom.

The system may further comprise a further feed roller 104 and a further arrest roller 120. The further feed roller 104 may advance the print medium P in the advance direction A. The further arrest roller 120 may be arranged below the further feed roller 104 such that the further arrest roller 120 supports the print medium P if the print medium P is present between the further feed roller 104 and the further arrest roller 120, and that the further feed roller 104 abuts against the further arrest roller 120 if no print medium P is present between the further feed roller 104 and the further arrest roller 120. The feed roller 104 and the further feed roller 104 may be driven by a single actuator 124, as for example shown in FIG. 9.

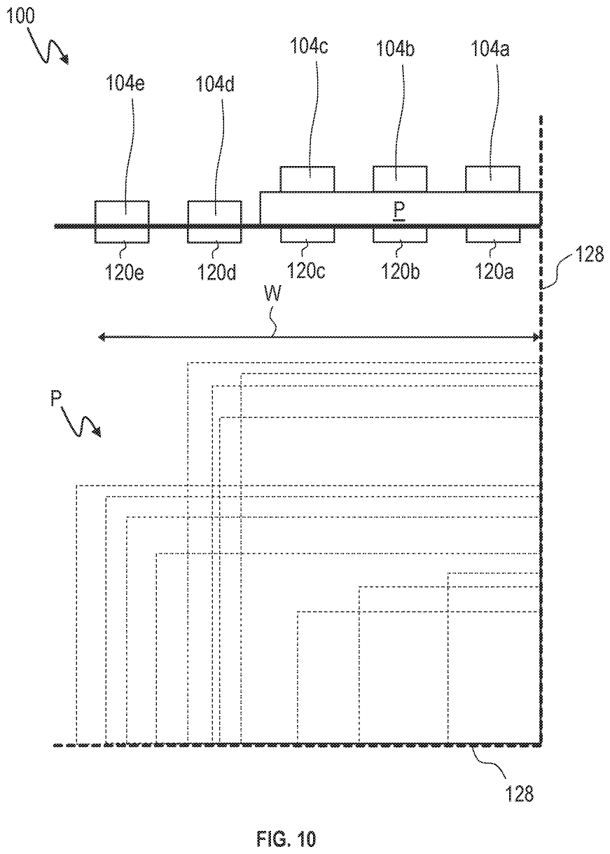

The present disclosure may be applicable to any size of the print medium. As shown in a schematic front view in FIG. 10, another examples of the printing device 100 may comprise rollers 104a to 104e arranged in a distributed manner along the width direction W. The print medium P may extend, from an alignment line 128 on the right-hand side in FIG. 10, below the rollers 104a, 104b and 104c. The corresponding arrest rollers 120a, 120b and 120c may retain the print medium P from being moved in the advance direction A by the rollers 104a, 104b and 104c in the above described manner.

The print medium P does not extend below the rollers 104d and 104e. Accordingly, the rollers 104d and 104e rest on (directly contact) the corresponding arrest rollers 120d and 120e. The arrest rollers 120a to 120e may be each provided in the above described manner, thereby allowing all of the rollers 104a to 104e to rotate regardless of being on the print medium P or on the respective arrest rollers 120a to 120e.

In a lower part of FIG. 10, different sizes of the print medium P are schematically depicted in an aligned manner to alignment lines 128. The present disclosure may be usable with any of the sizes shown in FIG. 10.

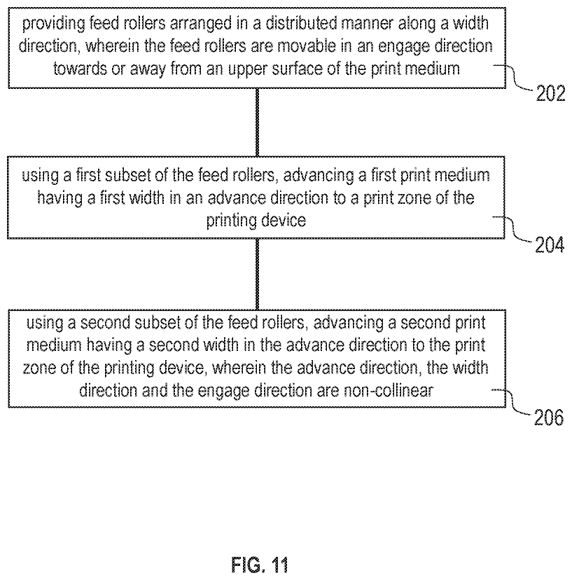

A further aspect of the present disclosure provides a method of operating a printing device or a system as shown in FIG. 11. The method may be suited to operate any examples of the printing device 100 and the system described above. In the method, at 202, feed rollers may be provided, which are arranged in a distributed manner along a width direction, wherein the feed rollers are movable in an engage direction towards or away from an upper surface of the print medium. At 204, using a first subset of the feed rollers, a first print medium is advanced that has a first width in an advance direction to a print zone of the printing device. At 206, using a second subset of the feed rollers, a second print medium is advanced that has a second width in the advance direction to the print zone of the printing device. The advance direction, the width direction and the engage direction may be non-collinear. In particular, some of the feed rollers may be included in both the first subset and the second subset. The feed rollers of the first subset may be neighboring feed rollers. The feed rollers of the second subset may be neighboring feed rollers. A number of feed rollers of the first subset and a number of feed rollers of the second subset may differ from each other.

The present disclosure allows printing with print media of wide range of thickness and sizes. The disclosed device, system and method may be adapted to any thickness range. The present disclosure allows for nonstop printing between print media of different sizes, for the present disclosure may accept one sheet of each size or thickness without a stop for re-adjust. Furthermore, the present disclosure employs simple hardware without any special sensor or hardware to re-adjust.

The foregoing outlines features of several examples to illustrate aspects of the present disclosure. Various changes, substitutions, and combinations of the features herein disclosed can be made without departing from the scope of the present disclosure. Features of one or different examples may be combined to implement different aspects of this disclosure, while other features may be omitted.

1. A printing device, comprising:
a support member to support a print medium;
multiple rollers each to advance the print medium from the support member in an advance direction,
wherein the multiple rollers are arranged in a distributed manner along a width direction,
wherein the multiple rollers are operable in a disengage state detached from the print medium and the support member and in an engage state of pressing against the support member such to rest on the print medium or, if the print medium does not extend therebetween, to rest on the support member,
wherein the multiple rollers in the engage state are individually movable toward the support member.

2. The printing device of claim 1, wherein the support member comprises an arrest roller arranged below one roller of the multiple rollers such that the one roller abuts against the arrest roller if no print medium is present between the one roller and the arrest roller, and that the arrest roller supports the print medium if the print medium extends between the one roller and the arrest roller.

3. The printing device of claim 2,
wherein the multiple rollers are arranged such to physically contact an upper surface of a print medium,
wherein the arrest roller provides inertia of torque and friction to apply a surface force to a lower surface of the print medium.

4. The printing device of claim 2, further comprising:
a torque limiter mechanically coupled to the arrest roller to allow the arrest roller to be rotated by the one roller if no print medium is present between the one roller and the arrest roller, and otherwise to block rotation of the arrest roller.

5. The printing device of claim 2,
wherein the support member comprises multiple arrest rollers each provided for a respective one of the multiple rollers.

6. The printing device of claim 1, further comprising:
a torque limiter mechanically coupled to one roller of the multiple rollers to limit a torque output by the one roller.

7. The printing device of claim 1, further comprising:
a lock device to detach the multiple rollers from the support member or the print medium and keep the multiple rollers in the disengage state.

8. The printing device of claim 1, further comprising:
a shaft to transmit a torque, wherein the multiple rollers are each mechanically coupled to the shaft to be driven by the torque received from the shaft.

9. The printing device of claim 8, further comprising:
a transmission gear to transmit the torque from the shaft to a respective one roller of the multiple rollers.

10. The printing device of claim 1,
wherein one roller of the multiple rollers is arranged such to be associated with a first print medium width and another roller of the multiple rollers is arranged such to be associated with a second print medium width that is different from the first print medium width.

11. The printing device of claim 1, wherein the multiple rollers are to feed a single print medium sheet from the support member to a print zone in the advance direction perpendicular to the width direction.

12. A system to feed a print medium to a print zone of a printing device, comprising:
a feed roller to advance a print medium in an advance direction;
an arrest roller arranged below the feed roller such that the arrest roller supports the print medium if the print medium is present between the feed roller and the arrest roller, and that the feed roller abuts against the arrest roller if no print medium is present between the feed roller and the arrest roller; and
a torque limiter mechanically coupled to the arrest roller.

13. The system of claim 12, further comprising:
a further feed roller to advance the print medium in the advance direction; and
a further arrest roller arranged below the further feed roller such that the further arrest roller supports the print medium if the print medium is present between the further feed roller and the further arrest roller, and that the further feed roller abuts against the further arrest roller if no print medium is present between the further feed roller and the further arrest roller,
wherein the feed roller and the further feed roller are driven by a single actuator.

14. The system of claim 12, wherein the feed roller is movable in an engage direction such to contact an upper surface of the print medium or to be detached therefrom.

15. A method of operating a printing device, comprising:
providing feed rollers arranged in a distributed manner along a width direction, wherein the feed rollers are movable in an engage direction towards or away from an upper surface of the print medium;
using a first subset of the feed rollers, advancing a first print medium having a first width in an advance direction to a print zone of the printing device;
using a second subset of the feed rollers, advancing a second print medium having a second width in the advance direction to the print zone of the printing device,
wherein the advance direction, the width direction and the engage direction are non-collinear.
